(19) United States
(12) Patent Application Publication
(10) Pub. No.: US 2004/0158529 A1
(43) Pub. Date: Aug. 12, 2004

(54) Open access data transport system and method

(75) Inventors: Ernie Bray, Orem, UT (US); David Shaw, West Jordan, UT (US)

Correspondence Address: THORPE NORTH & WESTERN, LLP., 8180 SOUTH 700 EAST, SUITE 200, P.O. BOX 1219, SANDY, UT, 84070, US

(73) Assignee: Dynamic City Metronet Advisors, Inc.

(21) Appl. No.: 10/630,648

(22) Filed: Jul. 30, 2003

Related U.S. Application Data
(60) Provisional application No. 60/399,884, filed on Jul. 30, 2002.

(51) Int. Cl. G06F 17/60

(52) U.S. Cl. 705/52

(57) ABSTRACT

A method for providing data transport services includes the steps of providing a publicly-owned, high-capacity communications network, allowing connection of the communications network to retail vendors and paying customers, and charging tolls for use of the communications network by the vendors and customers, without regard to the type or content of the data transmitted.

The present application claims priority from Unites States Provisional patent application serial No. 06/399,884, filed on Jul. 30, 2002 and entitled OPEN ACCESS DATA TRANSPORT SYSTEM AND METHOD.

### BACKGROUND OF THE INVENTION

1. Field of the Invention

The present invention relates generally to data transport systems. More particularly, the present invention relates to an open access data transport system and method wherein the data transport and retail services aspects of the system are functionally separated, such that any user of the system can receive data services from any retail service provider.

2. Related Art

Conventional telephone systems are often termed Intelligent Networks, which require very complex switching and routing hardware and software to control communications traffic. The very complexity of the network necessitates close control by the telephone company. The classic telephone company philosophy generally holds to several basic assumptions: that expensive, scarce infrastructure can be shared to offer premium priced services; that talk—the human voice-generates most of the traffic; and that circuit-switched calls are the “communications technologies” that matter the most. Telephone companies tend to operate under the belief that these assumptions hold, despite major changes in the communications landscape in the recent past. For example, during the past two decades there have been drastic declines in key infrastructure costs. At the same time, there has been a mushrooming of data traffic, with a wide variety of data types now traveling over the telephone network. There are now many different types of “communications technologies,” from television to Ethernet, that are not part of telephone network architecture. Perhaps most importantly, the Internet, because it makes the details of network operation irrelevant, is shifting control to the end user.

Given these changes, many experts believe there is no longer first-order economic justification for a telephone company to engineer and control scarce, expensive, network resources. In other words, the basic assumptions no longer apply. Information and computing advances of the past twenty years or so have ushered in the age of plentiful computing. For example, many home computer users today run screen-saver programs that require more computing power than small mainframe systems had just twenty years ago. The designers of the Intelligent Network never imagined such “wasteful” use of processing “intelligence” because it was so scarce and expensive when today's telephone system was designed so many years ago.

The age of plentiful bandwidth is also just around the corner, as several families of technologies (including fiber, satellite, cable modems, xDSL, LMDS, and low power TV, and others) offer the potential to break the local bandwidth bottleneck, and as the capacity of basic optical fiber has risen from 2 to 6 to 10, 20 and 40 Gbits per second over just the last few years. At the same time, the age of centralized control is ending, with the rise of the next generation of Internet—and especially the appearance of circuit-like Internet mechanisms, such as those in the latest version of Internet Protocol (IPv6), designed to tame delay and improve real-time two-way Internet voice.

Unfortunately, there is a comparative drought of capacity in today's metro networks, where T-1s (at 1.5 megabits/sec) are still considered “high speed” connections (vs. 10/100 Megabit LANs). With corporate Ethernet networks running at 10/100/1,000 Megabits per second, there is no real shortage of bandwidth within corporate LANs. However, unless massive, cheap public network connections between these LAN islands becomes available, there will be no reason to redesign or improve them.

Given these changing circumstances, one might think that there is a large incentive for telephone companies to reengineer themselves to serve the growing telecommunications demands, and that the main beneficiaries of the Intelligent Network are the telephone companies themselves. However, telephone companies have an enormous bureaucracy that moves and changes very slowly, especially where implementation of certain new technologies is concerned. Many observers believe that there is actually very little incentive for them to increase the capacity of their systems because the up-front infrastructure cost is very high and the payoff is not at all certain, or very slow. One thing the telephone companies have done is try to stand in the way of various new technologies that threaten their hegemony. Thus, new technologies that drastically increase data transmission capability could take years, or even decades after the real need becomes apparent for their implementation by the telephone companies.

Fortunately, the Internet breaks the telephone company model by passing control to the end user. It does this by taking the underlying network details out of the picture. Telephone networks have been designed for optimal use of scarce resources. If network design were based on another assumption—that computation and bandwidth were cheap and plentiful—this would lead to a new network philosophy and architecture, which would replace the vision of an Intelligent Network. The new philosophy and vision is that of a “Stupid Network,” one in which the public communications network is engineered for “always-on” use, not intermittence and scarcity. It would be engineered for intelligence at the end-user's device, not in the network. The “Stupid Network” would be engineered simply to deliver raw data, not for fancy network routing or smart number translation.

Many leaders in the telecommunications field have recognized a need for such a “Stupid Network.” The telephone companies are beginning to realize this, too. Fearing erosion of their control and, more importantly, their revenue stream, they have been quick to call for the banning of Internet Telephony, quick to call for the federal imposition of charges on Internet access, and slow to implement widely available, reasonably priced broadband services. The telephone companies are still speeding further deployment of Intelligent Network services.

However, whether it happens by evolution (i.e. slowly) or revolution (quickly), most forward-thinking experts agree that the data-intensive network of the future will be radically different from the voice-centric network of today. It appears unlikely that today's voice-centric telephone networks can be successfully evolved into low-cost, high speed data-centric networks that the future will demand. Existing, voice-centric network designs are simply not flexible or high-capacity enough to deliver data to match the capabilities of local networks.

A rudimentary form of the Stupid Network—the Internet—is here today. The Internet theoretically provides a neutral platform or “commons” that provides freedom and spurs creativity and innovation. However, Lawrence Lessig, a professor at Stanford Law School, suggests that the neutral platform, or commons, on which this freedom thrives, faces a mortal threat from entrenched telecommunications, cable and media interests. The Internet until now has been designed so that the network owner is not in a position to exercise control over the content or applications that run on it. The right to innovate is therefore held in common among all people who use the network. That right cannot be checked by the network owner. This freedom is increasingly under threat. The danger is that one class of property owners (e.g. telephone companies) will use the legal system to veto certain kinds of innovation that no longer accord with its business interests. These owners could gain the power to choose what kind of innovation is permitted. That condition is inconsistent with the idea of an innovation commons.

The Stupid Network solves these problems. The concept is that the Stupid Network provides nothing but dumb transport in the middle, with intelligent user-controlled endpoints. The design is guided by plenty, not scarcity, and transport is guided by the needs of the data, not the design assumptions of the network. In the current telephone network, voice is the assumed data type, unless specially ordered, high cost services are ordered. In contrast, the Stupid Network would let you send mixed data types at will—limited only by the knowledge and imagination of the application programmer community. One-way voice messages, multi-way voice conferences, two-way video, email, documents, audio and/or video entertainment, whatever, could be mixed and interspersed at will. You would not have to ask your Stupid Network provider for any special network modifications—its only function would be to, “Deliver the Bits, Stupid.”

Eventually, this sort of data-optimized model is likely to emerge as the new reference standard. However, while the Stupid Network concept has gained much attention and makes perfect sense, from a practical standpoint, it has not yet been determined how to put it into practice. The Stupid Network is not here yet. It is in its infancy, and is still mostly just a proposal. Translating this basic concept into a real-life network made of real-world equipment is a problem that has not yet found a solution. There are probably two main reasons. The first is the lethargy and resistance to change of the incumbent telephone companies. The second is that no economically viable business model has yet been formulated to implement the Stupid network.

The Internet is the main driver of data traffic growth, and almost all of that traffic flows over public network connections. Currently, however, we are still trying to force all that data through a network model that was fundamentally designed to carry voice. The recent orgy of capital spending by telephone companies is a direct result of carriers (new and old) trying to push high-volume data through networks designed for low-volume voice. It is this frenzy of spending that led to capital expenditures growth of 30% vs. revenue growth of 10% in the year 2000. It was, in part, the lack of return on those investments that led to the Internet stock train-wreck in 2001.

While, at the present time, growth in internet-related businesses may be leveling off for some time, eventually there will be significant, disruptive changes in the architecture of public networks and the equipment that supports them. One of the biggest hurdles to implementing the Stupid Network is the infrastructure required. Given the very high up-front cost of installing large quantities of optical fiber, an economically viable method for creating such a system is needed, but heretofore has not been available.

### SUMMARY OF THE INVENTION

It has been recognized that there is a need for a high-speed, high-capacity data transport network that is available to everyone.

It has also been recognized that a business model is needed to allow such a network to be economically developed.

The present invention advantageously provides a method for providing data transport services. The method includes the steps of providing a publicly-owned, high-capacity communications network, allowing connection of the communications network to retail vendors and paying customers, and charging tolls for use of the communications network by the vendors and customers, without regard to the type or content of the data transmitted. The network may consist of high-capacity fiber optic communication lines and end-user connections.

In accordance with a more detailed aspect of the present invention, the invention provides a method for providing a publicly-owned, high-capacity communications network. The method includes the steps of: (1) contracting by a governmental organization to construct a high-capacity fiber optic communication network within an area served by the governmental organization; (2) interconnecting the network to other networks in other areas; (3) allowing residents within the area to use the network and to obtain services over the network from any retail service provider; and (4) collecting service fees from users of the network and/or retail service providers to pay for the cost of construction and maintenance of the network.

In accordance with another aspect of the present invention, the invention provides a high-capacity, open-access communications network. The network includes an interconnected network of high-capacity fiber optic cable in a geographic region, configured to transport data without regard to the type or content thereof. A plurality of retail service providers are interconnected to the network, and a plurality of customers in the region are connected to the network and enabled to receive services from any of the retail service providers.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic plan view of an open access data transport system in accordance with an embodiment of the present invention.

FIG. 2 is a block diagram of the steps involved in the method for creating a viable system such as that shown in FIG. 1.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

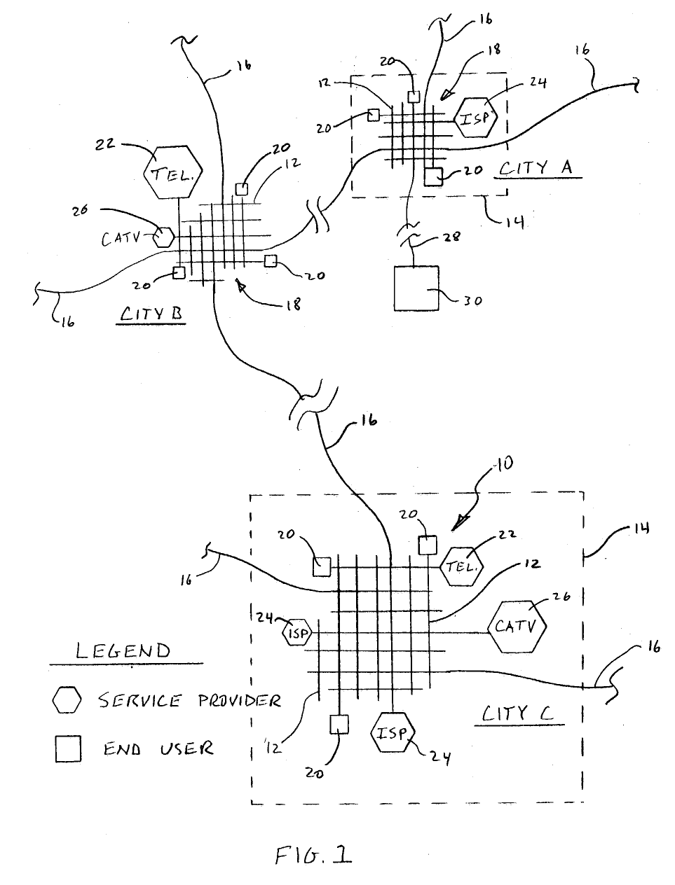

As illustrated in FIG. 1, one embodiment of a stupid network system 10 in accordance with the present invention comprises a network of high-capacity communication lines 12 that interconnect customers (end-users) 20 and service providers within the boundaries 14 of a particular geographic region. This region may be a city, county, or some other specially created district. The network is also connected via high-capacity communications lines 16 to other networks 18 that are in or extend to other areas, so that there is full connection to the outside world. Advantageously, the system links the end-users 20 to all service providers that are also connected to the network, whether directly locally or indirectly, regardless of their location (i.e. city A, B, or C). Additionally, a communications service region can extend lines outside of its boundary to serve specific customers where it is economically feasible. For example, City A could extend a dedicated line 28 to a large user of communications services 30 outside its boundaries 14.

With this system, consumers can obtain any desired service from any service provider in any location. For example, this system can provide true freedom of choice for cable television customers. Ordinarily, a local government will allow only one cable television company to build a network in its community. This is done to prevent the chaos of multiple cable companies competing to lay cable in the same space, and also because it is generally not cost effective for any cable company to install its cable network in an area where it cannot count on a virtual monopoly. The result is that residents of a particular area are faced with very limited television choices: receive free signals broadcast over the air, purchase cable television services from the local cable monopoly, or install an expensive satellite TV system.

With the present system, in contrast, all cable companies can compete for the business of any customer anywhere, in the same way that computer users have full choice of Internet service providers, regardless of geography. For example, as shown in City C, multiple cable TV companies (CATV) 26 can coexist in the same city and serve any customers there over the same network. However, a resident of City C could choose to receive the same services from a different cable company in City B, and residents of City B could choose to purchase services from a provider in City C.

Cable television services are just one example of the types of communications services that would be available over this network. The same is true for Internet Service Providers (ISP) 24 and telephone companies (TEL.) 22, whether local or long-distance. Any customer that is connected to the network can obtain services from any service provider that is connected to the network. And, because the network is a high-capacity fiber optic network, the quality of the signal can be much greater than what is currently possible with conventional telephone, cable or other existing communications lines. While the Internet currently works somewhat in this way, other services are not currently offered this way.

The system is intended to operate somewhat like a municipal water distribution network. All homes and business are (or at least can be) connected to the system, and receive whatever volume of services they choose, somewhat like choosing whether and how much to open a valve. Unlike a water system, however, that which comes over the system comes from any retail provider of the user's choice (e.g. a telephone company, cable television system, Internet service provider, etc.), and goes only to the purchasing customer. The owner of the network merely charges fees or tolls for use of the system, but does not control the system's operation, or the nature or content of the data that is transmitted. That is controlled at the endpoints (i.e. by the service provider at one end, and the customer at the other end). The network itself is stupid, like a big pipe. The system thus promotes completely free competition between all service providers for all services, including voice, data, television, Internet, etc.

The core of the new network is relatively simple, cheap and flexible. Yet it offers equal (or greater) functionality relative to the current, inflexible voice-centric model. Where current networks embed functionality in their cores (in the big, mainframe-like switches), a data-centric network as disclosed herein concentrates functionality at the network edge. The economics are fairly clear—adding functionality to the network core increases average costs for all bits carried. Adding functionality at the edge adds cost only for those bits that pass through those edge devices. A centralized architecture levies the same “tax” on each packet it carries, while an edge architecture only taxes those packets willing to pay for the extra functionality. Rather than making every packet pay for first-class service, the network optimizes around the fact that the vast majority of (data) packets will get along fine with best efforts service.

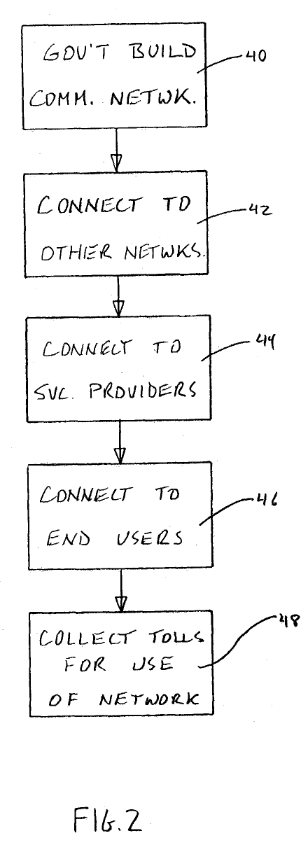

FIG. 2 presents a block diagram of a business method or model to allow such a system to be economically implemented. In essence, the invention provides a better method for providing data transport services. The primary goal is to provide a publicly-owned, open access high-capacity communications network. The first step toward this goal involves contracting, by a governmental organization, to construct a high-capacity fiber optic communication network (step 40) within an area served by the governmental organization. For example, a city or county government would construct the communications network as a part of the publicly-owned infrastructure of the area, in the same way the local culinary water distribution system is provided.

Of necessity, the network is also interconnected to other networks in other areas (e.g. the Internet) (step 42), so as to allow long distance communication, rather than create an isolated local network. The governmental entity then freely allows connection of the communications network to providers of communications services (step 44), and to end-users (step 46) of those services. Naturally, because a physical connection to the network is required, the customers will be residents of the area served. The customers may include residential, commercial, and other users of communications services.

Because the network is interconnected to other networks, especially the Internet, the service providers (voice, data, video, etc.) may be physically located anywhere, yet still provide services directly to the residents of the area. As noted above, this system allows free choice of cable television, local and long distance telephone services, Internet services, etc. Indeed, with this sort of system the lines between these services will begin to blur, and may disappear entirely, because one service provider would be able to provide telephone, television, Internet, and other such services to any customer anywhere.

The system also allows the streamlining of infrastructure. Rather than separate telephone, cable TV, and dedicated Internet connections (e.g. DSL lines), a single physical address (i.e. a building) would only need a connection to one communication line that would allow access to all of these services.

To pay for the system, the local governmental entity charges tolls for use of the communications network (step 48) to pay for the cost of construction and maintenance of the network. These tolls may be paid by the vendors of the services, the retail customers, or both, or by any other entity. Advantageously, access to the network is without regard to the identity of the customer or service provider, or the type or content of the data transmitted. The governmental entity simply provides the infrastructure that allows users to transmit whatever they will. With this invention, the infrastructure provider (the governmental entity) does not compete with network operators, so that the classic conflict-of-interest seen in deregulated legacy infrastructures does not occur.

By way of example, the invention can be described as a method for providing data transport services. The method includes the steps of providing a publicly-owned, high-capacity communications network, allowing connection of the communications network to retail vendors and paying customers, and charging tolls for use of the communications network by the vendors and customers, without regard to the type or content of the data transmitted. The network may consist of high-capacity fiber optic communication lines and end-user connections.

As another example, the invention can be described as a method for providing a publicly-owned, high-capacity communications network. The method includes the steps of: (1) contracting by a governmental organization to construct a high-capacity fiber optic communication network within an area served by the governmental organization; (2) interconnecting the network to other networks in other areas; (3) allowing residents within the area to use the network and to obtain services over the network from any retail service provider; and (4) collecting service fees from users of the network and/or retail service providers to pay for the cost of construction and maintenance of the network.

As yet another example, the invention can be described as a high-capacity communications network. The network includes an interconnected network of high-capacity fiber optic cable in a geographic region, configured to transport data without regard to the type or content thereof. A plurality of retail service providers are interconnected to the network, and a plurality of customers in the region are connected to the network and enabled to receive services from any of the retail service providers.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method for providing data transport services, comprising the steps of:
a. providing a publicly-owned, high-capacity communications network;
b. allowing connection of the communications network to service providers and paying customers; and
c. charging tolls for use of the communications network by the service providers and customers, without regard to the type or content of the data transmitted.

2. A method according to claim 1, wherein the network comprises high-capacity fiber optic communication lines and end-user connections.

3. A method according to claim 1, further comprising the step of interconnecting the high-capacity communications network to other communications networks.

4. A method according to claim 1, wherein the service providers are selected from the group consisting of cable television companies, telecommunications companies, and internet service providers.

5. A method according to claim 1, wherein the step of providing a publicly-owned, high-capacity communications network comprises constructing a fiber optic network within a geographic region controlled by a governmental entity.

6. A method according to claim 5, wherein the governmental entity is selected from the group consisting of a city, a county, a special district, a state, and a nation.

7. A method according to claim 5, wherein the fiber optic network is constructed using public funds.

8. A method according to claim 1, wherein the fees collected from users of the network and service providers are used to meet costs associated with the network.

9. A method for providing a publicly-owned, high-capacity communications network, comprising the steps of:
a. contracting by a governmental organization to construct a high-capacity fiber optic communication network within an area served by the governmental organization;
b. interconnecting the network to other networks in other areas;
c. allowing residents within the area to use the network and to obtain services over the network from any service provider; and
d. collecting service fees from users of the network and service providers.

10. A method according to claim 9, wherein the network comprises high-capacity fiber optic communication lines and end-user connections.

11. A method according to claim 9, wherein the service providers are selected from the group consisting of cable television companies, telecommunications companies, and internet service providers.

12. A method according to claim 9, wherein the governmental organization is selected from the group consisting of a city, a county, a special district, a state, and a nation.

13. A method according to claim 9, wherein construction of the high-capacity fiber optic communication network is funded with public funds.

14. A method according to claim 9, wherein the fees collected from users of the network and service providers are used to meet costs associated with the network.

15. A high-capacity communications network, comprising:
a. an interconnected network of high-capacity fiber optic cable in a geographic region, configured to transport data without regard to the type or content thereof;
b. a plurality of service providers, interconnected to the network;
c. a plurality of customers in the region, connected to the network and enabled to selectively receive services from any of the service providers.

16. A communications network according to claim 15, further comprising at least one connection to another communication network in another area.

17. A communications network according to claim 15, wherein the geographic region is a region selected from the group consisting of a city, a county, a special district, a plurality of counties, a state, and a nation.

18. A communications network according to claim 15, wherein the service providers are selected from the group consisting of cable television companies, telecommunications companies, and internet service providers.
